(19) United States
(12) Patent Application Publication
(10) Pub. No.: US 2009/0046200 A1
(43) Pub. Date: Feb. 19, 2009

(54) IMAGE CAPTURE DEVICE WITH DETACHABLE EXPANSION UNIT

(76) Inventors: Yang-Po Chiu, Taipei City (TW); Ing-Jye Huang, Taipei City (TW); Chun-Hsiung Wang, Taipei City (TW); Hsiang-Yun Chou, Taipei City (TW); Lian-Tien Ko, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/192,132

(22) Filed: Aug. 15, 2008

(30) Foreign Application Priority Data
Aug. 15, 2007 (TW) 096130142

(51) Int. Cl. H04N 5/225; G03B 7/26

(52) U.S. Cl. 348/372; 396/301; 348/E05.024

(57) ABSTRACT

The invention discloses an image capture device. The image capture device includes an image capture basic unit for capturing an image. The image capture basic unit includes a first power supply device for supplying an operating voltage and an expansion unit detachably coupled to the image capture basic unit. The expansion unit is utilized to provide a function of processing data to the image capture basic unit. The expansion unit further includes a second power supply device for supplying the operating voltage to the image capture basic unit.

### BACKGROUND OF THE INVENTION

1. Field of the Invention

The invention relates to an image capture device and, more particularly, to an image capture device having a detachable expansion unit.

2. Description of the Related Art

In recent years, along with the popularity of the digital camera and the mobile phone with a camera, people can record events in daily life by photographs or images, and demand for this aspect is also stimulated. To conveniently install a camera to the surrounding of a living environment, a mini camera is developed.

Since the mini camera has a small volume, a user can randomly fix it to any position in the living environment; for example, the mini camera can be attached to a wall by a magnetic, fixed to a head by a head belt, or fixed to a rail of a crib, etc. The main function of the mini camera is to shoot photographs or short movies, and the mini camera can be set to shoot photographs or movies in different modes according to different conditions. For example, the mini camera can automatically shoot photographs or movies at certain times, can be controlled by a remote controller to shoot photographs or movies, or can be triggered by an external sound or image to shoot photographs or movies, etc. The captured photographs or movies are stored in a built-in flash memory and are transmitted to a computer via a universal serial bus (USB). In addition, the images also can be transmitted to other digital devices in a wireless transmission mode with low power to be stored or viewed. For example, they can be transmitted via Zigbee. From the above, the mini camera has a plurality of functions. However, functions of interior elements of the camera are limited because of the small volume. For example, the capacity of a battery, the capacity of a storage device and the performance of a calculation chip are limited. Then, the usage convenience of the mini camera also decreases.

### BRIEF SUMMARY OF THE INVENTION

One objective of the invention is to provide an image capture device with a detachable expansion unit. In an embodiment of the invention, an image capture device is disclosed. The image capture device includes an image capture basic unit for capturing an image and an expansion unit detachably coupled to the image capture basic unit, wherein the image capture basic unit includes a first power supply device for supplying an operating voltage, and the expansion unit includes a second power supply device for supplying the operating voltage to the image capture basic unit.

In an embodiment of the invention, another image capture device is disclosed. The image capture device includes an image capture basic unit for capturing an image and an expansion unit detachably coupled to the image capture basic unit and used for providing a data processing function for the image capture basic unit.

### BRIEF DESCRIPTION OF THE SEVERAL VIEWS OF THE DRAWINGS

FIG. 1 is a functional block diagram showing an image capture basic unit applied to a mini camera;

FIG. 2 is a functional block diagram showing an expansion unit in one embodiment of the invention; and

FIG. 3 is a functional block diagram showing an adapter in one embodiment of the invention.

### DETAILED DESCRIPTION OF THE EMBODIMENTS

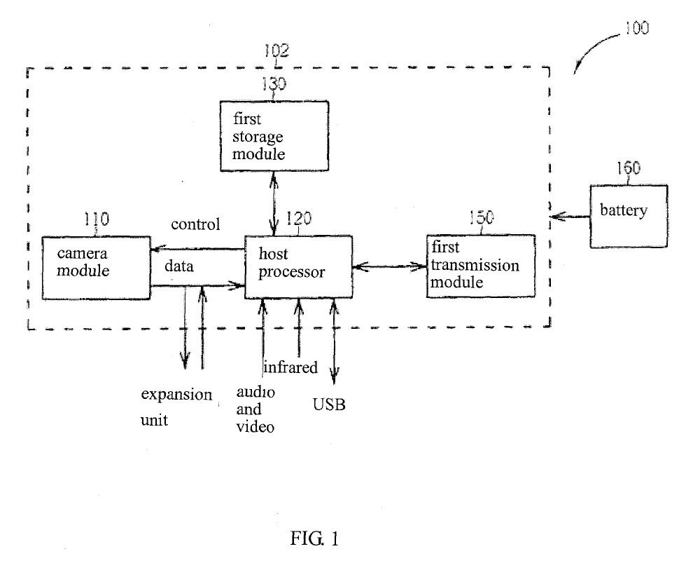

FIG. 1 is a functional block diagram showing an image capture basic unit 100 applied to a mini camera. The image capture basic unit 100 includes an image capture module 102 and a battery (power supply device) 160 as a power supplier. The image capture module 102 includes a camera module 110 for capturing image data, a host processor 120 coupled to the camera module 110 and used for processing and calculating the image data, a first storage module 130 coupled to the host processor 120 and used for storing the image data, and a first transmission module 150 coupled to the host processor 120 and used for transmitting the image data. The first storage module 130 can be composed of any elements which have a function of storing data. The first storage module 130, for example, a flash memory, a dynamic random access memory or the combination thereof.

First, the camera module 110 captures an image at certain times or when it is triggered by an external trigger (such as audio and video or infrared). After the captured image is compressed, it is stored to the first storage module 130 by the host processor 120. Then, the processed image data can be transmitted to other electronic device via the first transmission module 150, or it can be transmitted to a computer via a serial universal bus (USB).

Since the volume of the image capture basic unit 100 is small, the capacity of the battery 60 is limited, and functions of elements included by the image capture basic unit 100 are also limited because of the battery life of the battery 160 and the volume of the image capture basic unit 100. For example, for the present image compression and wireless transmission technology, the image compression with a high compressing ratio and the wireless transmission with a wide bandwidth consume much electric power, and therefore, considering the power consumption and the hardware cost, static photographs are stored with a standard joint photographic experts group (JPEG) format, and dynamic movies are compressed according to the motion joint photographic experts group (MJPEG) format. The first transmission module 150 utilizes the wireless transmission technology with low power such as the Zigbee technology, and therefore, the transmission rate is low, and the resolution and the frame rate of the transmitted image data are limited.

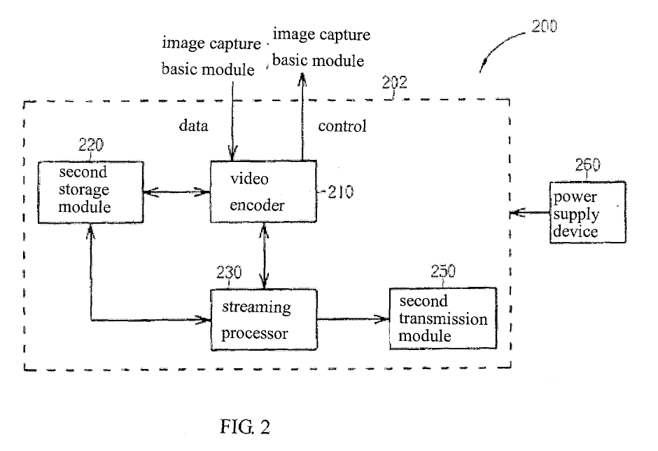

In some conditions, when the volume is not a main consideration factor, the embodiment of the invention discloses a detachable device which is an expansion unit connected to the image capture basic unit 100 to increase the power supply capability and the hardware calculation capability. As shown in FIG. 2, FIG. 2 is a functional block diagram showing an expansion unit 200 in one embodiment of the invention. The expansion unit 200 includes an expansion module 202 and a power supply device 260 as a power supplier. The expansion module 202 includes a video encoder 210 coupled to the image capture basic unit 100 and used for compressing image data, a second storage module 220 coupled to the video encoder 210 and used for storing compressed image data, a streaming processor 230 coupled to the video encoder 210 and the second storage module 220, used for processing video streaming for the video encoder 210 and storing video streaming data to the second storage module 220, a second transmission module 250 coupled to a streaming processor 230 and used for transmitting the video streaming data generated by the streaming processor 230. The mode shown in FIG. 2 is only an example and does not limit the scope of the invention.

The video encoder 210 in the expansion unit 200 is used for receiving the image data transmitted from the camera module 110 and compressing the image data into image data with a high compression ratio (such as the MPEG-4 format). Then, the compressed image data is stored to the second storage module 220, or it is transmitted to other electronic device via the second transmission module 250. The second transmission module 250 can utilize wireless network connection which satisfies, for example, the wireless fidelity (WiFi) standard to provide a higher data transmission rate.

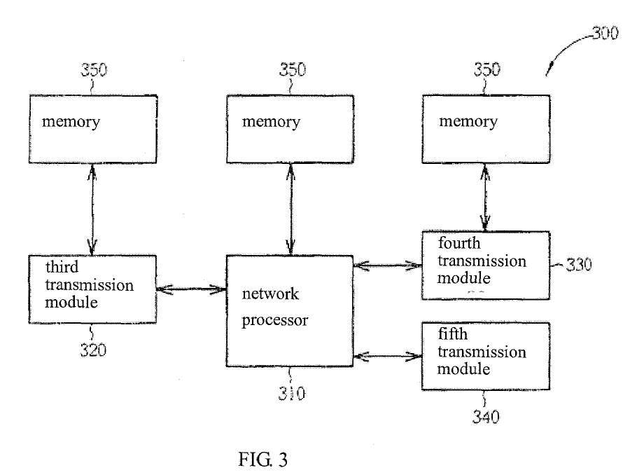

Since the first transmission module 150 in the image capture basic unit 100 utilizes the wireless transmission technology with low power such as the Zibee technology, an adapter is needed as the connection interface between the image capture basic unit 100 and other different network device. FIG. 3 is a functional block diagram showing an adapter 300 in one embodiment of the invention. The adapter 300 includes a network processor 310 for processing network data conversion such as converting a Zigbee data package to a WiFi data package, an Ethernet data package or a USB data package, a third transmission module 320 whose type is the same with the first transmission module 150, a fourth transmission module 330, a fifth transmission module 340 and a plurality of memories 350. The third transmission module 320 is a wireless transmission module with low power such as a Zigbee module, and the fourth transmission module 330 and the fifth transmission module 340 may be WiFi transmission modules, Ethernet transmission modules or USB transmission modules and so on.

The power consumption of the video encoder 210 and the second transmission module 250 used by the expansion unit 200 is more than the power consumption of the image capture basic unit 100 because the video encoder 210 and the second transmission module 250 utilize the compression technology with a high compression ratio and the wireless transmission mode with a high transmission rate. Therefore, in the embodiment, the power supply device 260 in the expansion unit 200 may use a battery with a large capacity or may be connected to an alternating-current power (that is, external power supply) to obtain sufficient electric power.

To sum up, in the expansion unit 200 shown in FIG. 2, the calculation module composed of the video encoder 210 and the streaming processor 230 can be used to expand the function of processing and computing data of the image capture basic unit 100 to provide greater data processing capability. The second storage module 220 is used to expand the data storage capacity of the image capture basic unit 100. The second transmission module 250 is used to expand the data transmission function of the image capture basic unit 100. The power supply device 260 can directly (without voltage conversion) or indirectly (by voltage conversion) supply a needed operating voltage to the image capture basic unit 100 to prolong the operation time of the image capture basic unit 100 under an condition that the power supply capability of the image capture basic unit 100 is limited.

Generally speaking, since the image capture basic unit 100 of the mini camera is designed to be capable of being fixed in different usage environment in different modes, the expansion unit 200 is mostly designed to be a module. That is, it can be detachably coupled to the image capture basic unit 100. In this way, expansibility and mobility are both considered. However, the invention is not limited by this. For example, the expansion unit 200 may be a portable device (such as a notebook computer), and the mini camera (namely the image capture basic unit 100) may be a portable device capable of being externally connected to the notebook computer and provides a function of capturing images. In other words, in the embodiment, the notebook computer and the mini camera are detachably connected to each other to form an image capture device, and then, a user can selectively make the mini camera (namely the image capture basic unit 100) connected to the notebook computer (namely the expansion unit 200) according to their need. Therefore, the notebook computer can supply the needed electric power to the mini camera and/or supply powerful calculation capability to do complicated image processing on images captured by the mini camera, and this design is also within the spirit of the invention.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An image capture device comprising:
an image capture basic unit for capturing an image, wherein the image capture basic unit comprises a first power supply device for supplying an operating voltage; and
an expansion unit detachably coupled to the image capture basic unit, wherein the expansion unit comprises a second power supply device for supplying the operating voltage to the image capture basic unit.

2. The image capture device according to claim 1, wherein the image capture basic unit is a portable device.

3. The image capture device according to claim 1, wherein the expansion unit is a portable device.

4. The image capture device according to claim 1, wherein the expansion unit is a notebook computer.

5. The image capture device according to claim 1, wherein the expansion unit comprises:
a storage module for expanding data storage capacity of the image capture basic unit.

6. The image capture device according to claim 1, wherein the image capture device further comprises an adapter for converting the format of data of the captured image.

7. The image capture device according to claim 6, wherein the adapter utilizes a network processor to convert the data of the captured image to a wireless fidelity (WiFi) data package, an Ethernet data package or a universal serial bus (USB) data package.
